(19) United States
(12) Patent Application Publication
(10) Pub. No.: US 2009/0193247 A1
(43) Pub. Date: Jul. 30, 2009

(54) PROPRIETARY PROTOCOL TUNNELING OVER EAP

(76) Inventors: W. Scott Kiester, Orem, UT (US); Cameron Mashayekhi, Salt Lake City, UT (US); Karl E. Ford, Highland, UT (US)

Correspondence Address: KING & SCHICKLI, PLLC, 247 NORTH BROADWAY, LEXINGTON, KY, 40507, US

(21) Appl. No.: 12/021,381

(22) Filed: Jan. 29, 2008

(51) Int. Cl. H04L 9/00

(52) U.S. Cl. 713/151

(57) ABSTRACT

Methods and apparatus provide tunneling one authentication framework over a more widely accepted framework (e.g., EAP). In this manner, pluralities of strong authentication protocols are wirelessly enabled between a supplicant and server that are not otherwise wirelessly enabled. During use, packets are wirelessly transmitted and received between the supplicant and server according to EAP's prescribed message format, including a wireless access point. In a tunnel, various authentication protocols form the payload component of the message format which yields execution capability of more than one protocol, instead of the typical single protocol authentication. Certain tunneled frameworks include NMAS, LDAP/SASL, Open LDAP/SLAPD, or IPSEC. Computer program products, computing systems and various interaction between the supplicant and server are also disclosed.

### FIELD OF THE INVENTION

Generally, the present invention relates to computing environments involving authentication frameworks. Particularly, although not exclusively, it relates to authentication frameworks in a wireless environment, especially those contemplative of the extensible authentication protocol (EAP) authentication framework. Features of the invention include tunneling a proprietary authentication framework over a more widely accepted framework, e.g., EAP, to wirelessly enable pluralities of strong authentication protocols that are not otherwise wirelessly enabled absent an EAP tunnel. Other features contemplate computer program products, computing network systems, authentication protocols, and retrofit technology, to name a few.

### BACKGROUND OF THE INVENTION

Many authentication systems, such as Novell, Inc.'s Modular Authentication Service (NMAS), provide varying levels of strong authentication. NMAS, for instance, can authenticate users using biometrics (e.g., fingerprint, retina scan, etc.), tokens (one-time passwords, smart cards), and passwords. Security sensitive applications or resources, such as corporate financial information, personal and personnel information, military secrets, nuclear technology, banking activity, securities trading, health/patient records, etc., use these authentication services to prevent unauthorized users from gaining access. During use, third parties “plug” NMAS into their computing environment and write a Login Client Method (LCM), for a client workstation, and a Login Server Method (LSM), for a server. The LCM is methodology largely responsible for collecting authentication credentials from users at their workstation, e.g., receiving one-time passwords, receiving fingerprint data from a scanner, etc., while the LSM is methodology largely responsible for authenticating or verifying the credentials.

The LCM and LSM communicate using proprietary NMAS API calls. These API calls take data provided by the caller, package it into MAF API packets, and send it over a network between the client workstation and server. The format of the data is not specified by NMAS, but is left to the discretion of the LCM/LSM developer. Login secrets (e.g., how one-time passwords are calculated, scanned fingerprint data for users, etc.) are stored for the server with the assistance of a computing product, such as Novell's eDirectory or Microsoft's Active Directory, and may be accessed from the LSM using NMAS API calls for storing and retrieving secrets.

However, it presently exists that NMAS and various other frameworks do not contemplate wireless computing scenarios, especially those involving the Extensible Authentication Protocol (EAP) that is regularly found in wireless networks and point-to-point connections. Defined by RFC 3748, EAP defines message formats and common functions for authenticators (e.g., authenticating server, including or not an EAP server) and peers (also known as supplicants in IEEE 802.1x) to negotiate a desired authentication method.

In that NMAS has existed longer than EAP, and there are several Novell partners who have developed login/authentication methods for NMAS (using proprietary NMAS API calls), the methods cannot be made to run directly in another framework, such as EAP, without modification or reimplementing NMAS protocol over EAP. Appreciating these types of updates are costly for NMAS partners, many are slow or altogether resistant to update their methods.

Accordingly, there exists a need in the art of strong authentication to allow users to login or be authenticated in a wireless computing environment without requiring costly updates to existing authentication methods within the framework. To the extent such can be made to occur, multiple authentication methods will then be made wirelessly-enabled whereas they are not otherwise wirelessly enabled. In that many computing configurations already have strong authentication services, it is further desirable to leverage existing configurations, thereby avoiding the costs of providing wholly new products. Taking advantage of existing frameworks, such as NMAS, LDAP/SASL, OpenLDAP/SLAPD, IPSEC, etc. or any authentication framework is another feature that optimizes existing resources.

Also, EAP has long prevented conversation between the authenticator and peer about multiple authentication methods due to their vulnerability from man-in-the-middle attacks. To combat this, LAP has supported tunneling, but only for a single EAP authentication method inside the tunnel. Never has there been executions of LDAP/SASL, for instance, inside the tunnel. While many tunneling methods exist, each has its shortcomings. Common ones include, but are not limited to, EAP-TLS, EAP-TTLS, and PEAP. Essentially, EAP-TLS is an X.509 mutual authentication requiring certificates of the client, and is seldom deployed for this reason. While EAP-TTLS does not require client authentication, it is primarily used to provide a secure channel for password based authentication methods, not strong authentication. PEAP provides a secure channel for password based authentication methods, not strong authentication, similar to EAP-TTLS, but with security and performance improvements. Regardless of form, each of the tunneling EAP methods (with the exception of EAP-TLS) commonly provide an encrypted channel in which to execute another individual EAP method or legacy PPP (point-to-point protocol) method. Also, the tunneling EAP methods cannot be forced to execute a non-EAP/non-PPP authentication scheme, such as SASL or NMAS, inside of the tunnel.

Accordingly, there is a further need in the art of authentication frameworks to provide authentication in other than the EAP or PPP authentication schema, including wirelessly enabling a multi-factor, pluggable authentication framework like SASL or NMAS. Any improvements along such lines should further contemplate good engineering practices, such as relative inexpensiveness, stability, ease of implementation, high security, low complexity, flexibility, etc.

### SUMMARY OF THE INVENTION

The foregoing and other problems become solved by applying the principles and teachings associated with the hereinafter-described proprietary protocol tunneling over EAP. At a high level, methods and apparatus teach tunneling a proprietary authentication framework over a more widely accepted framework, e.g., EAP, to wirelessly enable pluralities of strong authentication protocols that are not otherwise wirelessly enabled absent the EAP tunnel. In a representative embodiment, the invention(s) herein describe how an NMAS method for EAP can be created to allow all existing NMAS methods to work within the EAP framework without modification. As is known, NMAS provides fifty-plus existing authentication methods and the invention(s) provide advantage over the prior art since all can be wirelessly enabled without modification to the methods. It is not limited to NMAS, however, and other strong, multi-factor authentication frameworks, such as LDAP/SASL, OpenLDAP/SLAPD, IPSEC, etc., can derive advantage based on the techniques and computing arrangements herein.

During use, packets are wirelessly transmitted and received between a supplicant and authenticating server according to EAP's prescribed message format, including an intervening access point communicating with the server and wirelessly communicating with the supplicant. In a tunnel, various authentication protocols form the payload component of the EAP message format, thereby yielding execution capability of more than one protocol, instead of the typical single protocol authentication.

In a computing system embodiment, the invention may be practiced with: a client workstation; and an authenticating server arranged as part of pluralities of physical or virtual computing devices, including executable instructions for undertaking the foregoing tunneling methodology. Computer program products are also disclosed and are available as a download or on a computer readable medium. The computer program products are also available for installation on a network appliance, such as an authenticating server, on a supplicant, such as a client workstation or as retrofit technology with a strong authentication service, such as Novell, Inc.'s NMAS, or with other strong, multi-factor authentication frameworks, such as LDAP/SASL with/without PAM, OpenLDAP/SLAPD, or elsewhere. In still other embodiments, computing networks and party interaction are discussed, as are possible strong authentication schemes, e.g., smart card, one-time passwords, fingerprint, DNA, retina scan, etc.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for proprietary protocol tunneling over EAP;

FIGS. 2 and 3 are combined flow charts and diagrammatic views in accordance with the present invention for undertaking proprietary protocol tunneling over EAP; and

FIG. 4 is a diagrammatic view in accordance with the present invention of a message format for proprietary protocol tunneling over EAP.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for tunneling proprietary or other protocols over another protocol or framework (e.g., EAP) are hereinafter described.

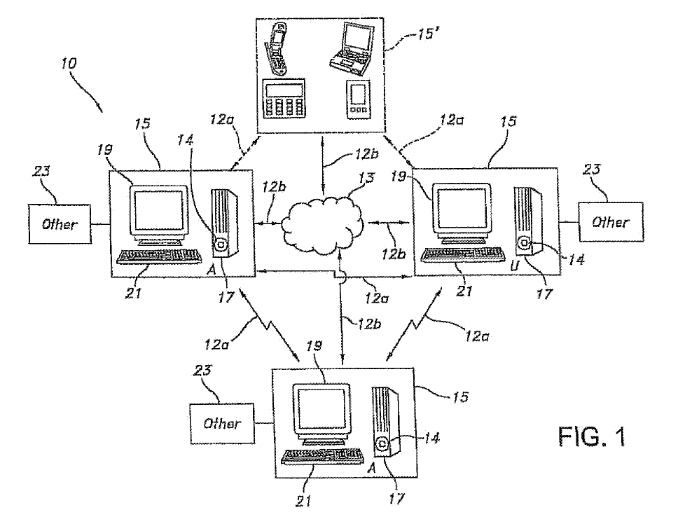

With reference to FIG. 1, a representative computing environment 10 for practicing certain or all aspects of the invention includes one or more computing devices 15 or 15′ arranged as individual or networked physical or virtual machines, including clients or hosts arranged with a variety of other networks and computing devices. In a traditional sense, an exemplary computing device typifies a server 17, such as a grid or blade server. Brand examples include, but are not limited to, a Windows brand Server, a SUSE Linux Enterprise Server, a Red Hat Advanced Server, a Solaris server or an AIX server. Alternatively, it includes a general or special purpose computing device in the form of a conventional fixed or mobile (e.g., laptop) computer 17 having an attendant monitor 19 and user interface 21. The computer internally includes a processing unit for a resident operating system, such as DOS, WINDOWS MACINTOSH, LEOPARD, VISTA, UNIX, and LINUX, to name a few, a memory, and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer computing device, a broadcast antenna, a web server, an AJAX client, a grid-computing node, a virtual machine, a web service endpoint, a cellular phone, or the like. The other items may also be stand alone computing devices 15′ in the environment 10 or the computing device itself.

In either, storage devices are contemplated and maybe remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computer 17. Computer executable instructions may also be available for installation as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download of executable instructions resident with a downstream computing device, or readable media, received from an upstream computing device or readable media, a download of executable instructions resident on an upstream computing device or readable media, awaiting transfer to a downstream computing device or readable media, or any available media, such as RAM, ROM, EEPROM, CD-ROM, DVD, or other optical disk storage devices, magnetic disk storage devices, floppy disks, or any other physical medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T# lines, satellites, microwave relays or the like. The connections may also be local area networks (LAN), metro area networks (MAN), and/or wide area networks (WAN) that are presented by way of example and not limitation. The topology is also any of a variety, such as ring, star, bridged, cascaded, meshed, or other known or hereinafter invented arrangement.

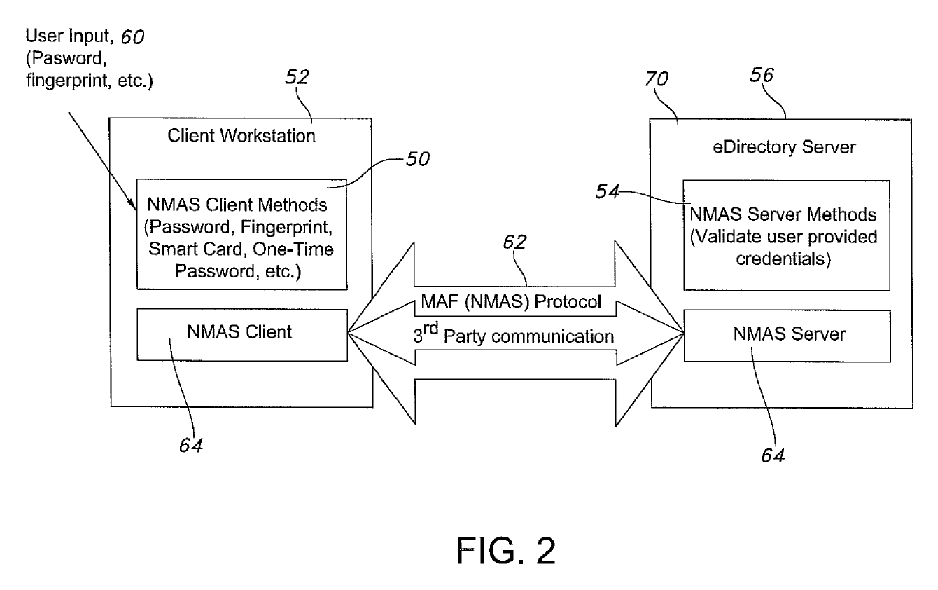

With the foregoing representative computing environment as backdrop, FIG. 2 teaches a more detailed example of an embodiment of the invention given in the context of a wired NMAS/eDirectory computing arrangement, representative of a strong, multi-factor authentication framework. Other existing frameworks relevant to this scenario include, but are not limited to, LDAP/SASL (Lightweight Directory Access Protocol/Simple Authentication and Security Layer), OpenLDAP/SLAPD (Open Lightweight Directory Access Protocol/stand-alone LDAP daemon) or IPSEC (Internet Protocol Security). Other applicable directories include, Active Directory or Sun One, for instance, but appreciating Active Directory is not nearly as lightweight as eDirectory.

With NMAS, third parties “plug” the computing program product into their computing environment 10 and write/provide a Login Client Method (LCM) 50 for a client workstation 52 and a Login Server Method (LSM) 54 for a server 56, as is known. In general, the LCM is methodology largely responsible for collecting authentication credentials (user input information 60) from users at their workstation, e.g., receiving one-time passwords, receiving fingerprint data from a scanner, receiving an employee bar code, etc., while the LSM is methodology largely responsible for authenticating or verifying the credentials per a user, a workgroup, or other arrangement.

Also, NMAS may be outfitted with various schemes providing varying levels of strong authentication. In one instance, the authentication schemes relate to user-fixed characteristics such as biometrics in the form of fingerprints, retina scans, DNA, etc. In another, they relate to electronic structures, such as smart cards, microchips, magnetic stripes, etc. In still another, they are user-created, such as passwords, secrets, usernames, PINs, or other credentials. Regardless of form, they are referred to generically herein as protocols, methods, schemes, etc. and users log-in from their workstation, including navigation with apparatus such as card readers, retina or fingerprint scanners, password forms, keypads, etc., as is typical. (In certain embodiments, the workstation may be simply a computing device in the form of a card reader, retina or fingerprint scanner, password form, keypad, etc., such as 15′ in FIG. 1 without the more traditional form of element 15 in FIG. 1.)

When the client workstation and server are in communication, the LCM and LSM communicate using proprietary NMAS API calls 62. These API calls take data provided by the caller, package it into MAF (Multi-mode Authentication Framework) API packets, and send it over a network between the client workstation 52 and server 56, especially between the NMAS client 64 and NMAS server 66. In turn, the NMAS client and server communicate with the LCM and LSM, respectively. The format of the data is not specified by NMAS, but is left to the discretion of the LCM/LSM developer. Actual login secrets (e.g., how one-time passwords are calculated, scanned fingerprint data per specific users, employee card values for users, workgroups, etc.) are stored for the server with the assistance of a computing product, such as Novell's eDirectory 70. As will be seen, this arrangement extends to a wireless computing environment in which the framework itself will be tunneled intact over another framework, such as EAP, to wirelessly enable the pluralities of strong authentication schemes that are not otherwise wirelessly enabled absent the EAP tunnel. In this manner, NMAS's fifty-plus existing authentication schemes are enabled in a wireless environment without modification. It is also true of other strong, multi-factor authentication frameworks, such as LDAP/SASL, OpenLDAP/SLAPD, IPSEC, etc., earlier mentioned.

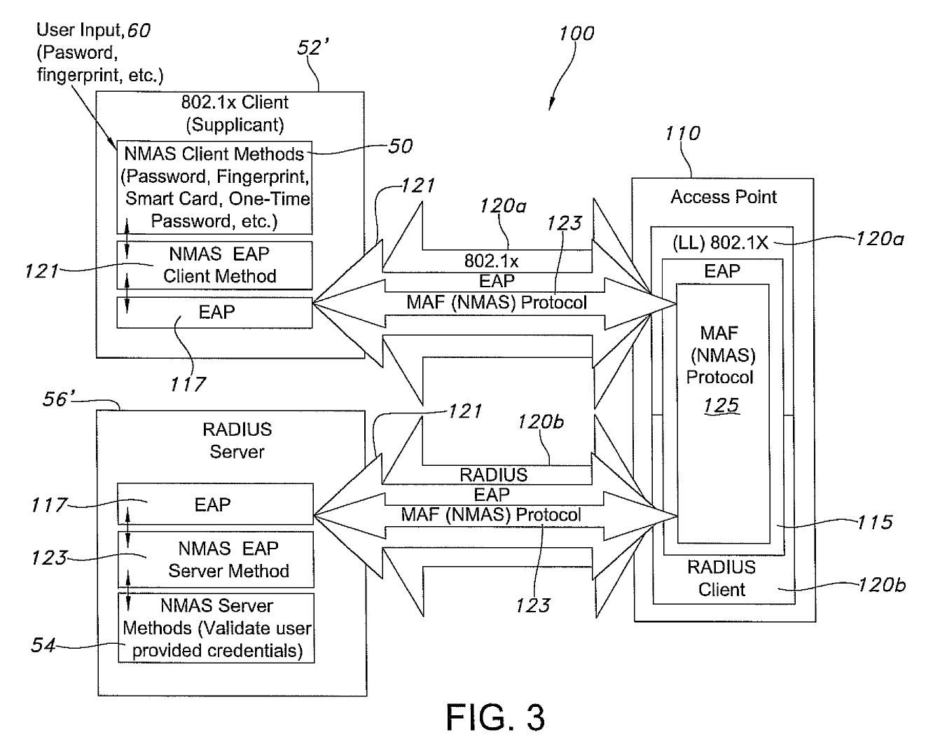

With reference to FIG. 3, a wireless environment is given as 100. It includes a client workstation and an authenticating server, as before, but now are labeled as a supplicant 52′ and a Radius Server 56′ as those terms are understood in the RFC 3748 context. Intervening the two, an access point 110 includes an authentication framework in the form of EAP 115. The framework communicates directly with the server and wirelessly with the supplicant. It transmits and receives packets between the two in an EAP layer 117 according to known EAP message formatting 121. In a tunnel 123, the payload 125 of the message, however, is that of the MAF (NMAS) protocol so that the pluralities of authentication schemes of NMAS, for instance, can be utilized by a user of the supplicant for login or other verification, without modification to any of the individual authentication schemes. In a lower layer (LL) 120, EAP runs in the form of 802.1x, 120a, or PPP with the Radius Server 120b. Of course, other lower layers are possible and include, wired IEEE 802 LANs, IEEE 802.11 wireless LANs, UDP, IKEv2 or TCP, or other. In still other embodiments, a dedicated EAP server (not shown) may also accompany the authenticating server, as is known in the art.

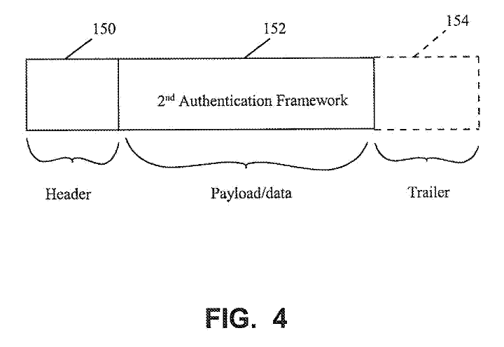

In FIG. 4, the actual message format of EAP includes a header 150 with a payload 152. In the header, any of a variety of bits form a type, length, code or other identifier. In the payload, the actual authentication framework is provided. During use, upon a few round trips of a conversation between the supplicant and server, the pluralities of authentication schemes of the framework become functional not merely a single authentication scheme with traditional EAP conversations. (A trailer 154 may also be used in the message formatting). As a result, the invention finds advantage by tunneling an entire authentication protocol or framework, over another, to allow existing authentication schemes to be used in an 802.1x environment, an environment which they were not designed for.

The foregoing also includes a generic NMAS-EAP method 121, 123 (server or supplicant) which acts as a shim between the EAP protocol stack or layer and the NMAS methods. During use, the shim provides an implementation of the proprietary NMAS API that is required by the partner methods (e.g., one-time password, fingerprint, smart card, etc.). The shim allows the MAF protocol packets to be wrapped in EAP packets. When the EAP-NMAS method is invoked, it reads data from the server to determine which sequence of NMAS login methods should be invoked. These methods are invoked in order, just as when performing an ordinary NMAS login, such as with the wired environment of FIG. 2. Because the shim provides the full NMAS API set, any existing NMAS method may be invoked, without modification.

With reference to the EXAMPLE below, a more detailed explanation is given. It exists also in the context of NMAS and a strong authentication protocol in the form of a one-time password for Vasco corporation's Digipass product.

### EXAMPLE

1) The user initiates Client32 NCP login on the client workstation 52′ using the Vasco Digipass login method.

2) The NMAS Client invokes the Vasco Digipass LCM 50, which prompts the user for the token code. The user enters the token code and the token code is sent to the LSM 54 by way of the access point 110, as part of the EAP message format (via EAP 117 of the supplicant to EAP 115 to EAP 117 of the server).

3) The LSM 54 receives the token code from EAP 117 of the server. To verify the token code, the LSM looks up the token that is assigned to the user. For the Vasco method, the token is a separate object that is linked to the user using an attribute called vascoAssignedTokenDN. The Digipass LSM calls NMAS API 123 to read the vascoAssignedTokenDN attribute of the user. NMAS reads the attribute from the user and returns the results to Vasco LSM 54.

4) The LSM 54 calls NMAS_GetLoginSecret to read the token seed from the token object.

5) The LSM validates the token code provided by the user.

6) The LSM informs the LCM 50 of authentication via the access point as a payload of the EAP message format. Login is successful. Otherwise, if the token code is invalid, login is unsuccessful and certain or all functionality of the client workstation (supplicant) is prevented.

Similarly, other authentication schemes are practiced as encapsulated payloads of EAP. Other round trips between the supplicant and server may also exist, but are not discussed for clarity.

In any embodiment, certain advantages and benefits over the prior art should be readily apparent. For example, methods and apparatus teach an arrangement of computing devices whereby a first authentication framework is provided over another authentication framework in order to wirelessly enable multiple authentication schemes that are not otherwise wirelessly enabled without modification. Other advantages include, but are not limited to: 1) tunneling one pluggable authentication protocol (MAF) over another pluggable authentication protocol (EAP); 2) wirelessly enabling NMAS, LDAP/SASL, Open LDAP/SLAPD, and IPSEC, to name a few, which are otherwise unavailable for wireless authentication; 3) allowing strong authentication in geographic locations (reachable in a wireless context) not earlier able to provide strong authentication; and 4) leveraging existing configurations thereby avoiding the costs associated with providing wholly new products.

Still other advantages exist in the form of authentication schemes and party interaction as well as computer program products, computing networks and computing devices, to name a few. Also, features of the invention make it possible to use existing login methods, without modification, for wireless login. Naturally, skilled artisans will be able to contemplate others.

One of ordinary skill in the art will also recognize that additional embodiments are possible without departing from the teachings of the present invention. This detailed description, and particularly the specific details of the exemplary embodiments disclosed herein, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a tunneling method comprising:
providing a first authentication framework between a supplicant and an authenticating server; and
tunneling a second authentication framework over the first authentication framework, the second authentication framework having a plurality of strong authentication protocols that can be, used in a tunnel for authenticating the supplicant with the authenticating server.

2. The method of claim 1, wherein the providing the first authentication framework further includes providing a lower layer for transmitting and receiving packets between the supplicant and the authenticating server.

3. The method of claim 2, wherein the providing the lower layer further includes providing a PPP, IEEE-802.1x, IEEE-802.11, UDP, IKEv2 or TCP.

4. The method of claim 1, wherein the providing the first authentication framework further includes providing an EAP.

5. The method of claim 4, wherein the tunneling the second authentication framework over the first authentication framework further includes tunneling an NMAS computer program product over the EAP.

6. The method of claim 1, wherein the tunneling the second authentication framework over the first authentication framework further includes tunneling LDAP/SASL, Open LDAP/SLAPD or IPSEC over the first authentication framework.

7. In a computing system environment, a tunneling method comprising:
providing a first authentication framework for use in negotiating a desired authentication method between a supplicant and an authenticating server, the first authentication framework having a predefined message format; and
tunneling a second authentication framework over the first authentication framework, the second authentication framework included in the predefined message format and having a plurality of strong authentication protocols that can be used in a tunnel for authenticating the supplicant with the authenticating server.

8. The method of claim 7, wherein the providing the first authentication framework further includes providing a lower layer for transmitting and receiving packets of the predefined message format between the supplicant and the authenticating server.

9. The method of claim 8, wherein the transmitting and receiving packets of the predefined message format occurs wirelessly for at least a portion thereof.

10. In a computing system environment including a supplicant, an authenticating server, and an access point communicating with the authenticating server and in wireless communication with the supplicant, a tunneling method comprising:
providing a first authentication framework for use in negotiating a desired authentication method between the supplicant and the authenticating server, the first authentication framework having a predefined message format that is transmitted and received between the supplicant and the authenticating server by way of the access point intervening the supplicant and the authenticating server, the first authentication framework being an EAP; and
tunneling a second authentication framework over the EAP, the second authentication framework included in the predefined message format and being a multiple factor authentication framework with a plurality of strong authentication protocols that can be used in a tunnel for authenticating the supplicant with the authenticating server thereby wirelessly enabling the plurality of strong authentication protocols that are not otherwise wirelessly enabled.

11. In a computing system environment having a first authentication framework between a wirelessly arranged supplicant and an authenticating server, a tunneling method comprising:
tunneling a second authentication framework over the first authentication framework, the second authentication framework having a plurality of strong authentication protocols; and
authenticating a user of the supplicant with the authenticating server by at least one of the plurality of strong authentication protocols of the second authentication framework thereby wirelessly enabling the plurality of strong authentication protocols that are not otherwise wirelessly enabled.

12. The method of claim 11, wherein the tunneling the second authentication framework over the first authentication framework further includes tunneling the second authentication framework over an EAP.

13. The method of claim 11, wherein the tunneling the second authentication framework over the first authentication framework further includes tunneling NMAS, LDAP/SASL, Open LDAP/SLAPD or IPSEC over the first authentication framework.

14. The method of claim 11, wherein the first authentication framework has a predefined message format that is transmitted and received as packets between the supplicant and the authenticating server by way of an access point intervening the supplicant and the authenticating server, the second authentication framework included in the predefined message format.

15. In a computing system environment having an EAP between a wirelessly arranged supplicant and an authenticating server, a tunneling method comprising tunneling a second authentication framework over the EAP, the second authentication framework having a plurality of strong authentication protocols that are used for authenticating the supplicant with the authenticating server.

16. A computer program product available as a download or on a computer readable medium for loading on a computing device of a plurality of computing devices, the computer program product having executable instructions to provide tunneling, comprising:
a first component for installation on an authenticating server of the pluralities of computing devices, the first component to tunnel an authentication framework over an EAP to a client workstation of the pluralities of computing devices during a wireless connection between the client workstation and the authenticating server; and
a second component for authenticating the user according to a selected one of a plurality of authentication protocols thereby wirelessly enabling the authentication protocols that are not otherwise wirelessly enabled.

17. A computer program product available as a download or on a computer readable medium for loading on a computing device of a plurality of computing devices, the computer program product having executable instructions, comprising:
a first component for installation on a client workstation of the pluralities of computing devices, the first component to communicate with an authenticating server of the pluralities of computing devices via an authentication framework over a tunnel in an EAP during a wireless connection between the client workstation and the authenticating server; and
a second component for causing the authentication of the user according to a selected one of a plurality of authentication protocols of the authentication framework.

18. A computing system environment having pluralities of computing devices arranged to provide wireless communication, comprising:
a client workstation arranged as part of the pluralities of computing devices;
an authenticating server arranged as part of the pluralities of computing devices, the authenticating server having a first authentication framework with a plurality of strong authentication protocols that are used for authenticating a user of the client workstation with the authenticating server; and
a tunnel in a second authentication framework between the client workstation and the authenticating server, the second authentication framework being EAP and the tunnel including the first authentication framework for wirelessly enabling the strong authentication protocols that are not otherwise wirelessly enabled.

19. The computing system environment of claim 18, further including an access point connected directly to the authenticating server and wirelessly connected to the client workstation.

20. The computing system environment of claim 18, further including a lower layer for the EAP to transmit and receive packets between the client workstation and the authenticating server.

21. The computing system environment of claim 20, wherein the lower layer includes a PPP, IEEE-802.1x, IEEE-802.11, UDP, IKEv2 or TCP.

22. The computing system environment of claim 18, wherein the authenticating server is a radius server.

23. The computing system environment of claim 18, further including an EAP server communicating with the authenticating server.

24. The computing system environment of claim 18, wherein the authenticating server further includes an NMAS computer program.
